(19) United States
(12) Patent Application Publication
(10) Pub. No.: US 2012/0107790 A1
(43) Pub. Date: May 3, 2012

(54) APPARATUS AND METHOD FOR AUTHORING EXPERIENTIAL LEARNING CONTENT

(75) Inventors: Su Woong LEE, Daejeon (KR); Jong-Gook KO, Daejeon (KR); Junsuk LEE, Daejeon (KR); Seokbin KANG, Daejeon (KR); Jaemo SUNG, Daejeon (KR); Gil haeng LEE, Daejeon (KR)

(73) Assignee: Electronics and Telecommunications Research Institute, Daejeon (KR)

(21) Appl. No.: 13/285,378

(22) Filed: Oct. 31, 2011

(30) Foreign Application Priority Data
Nov. 1, 2010 (KR) 10-2010-0107502

(51) Int. Cl. G09B 25/00

(52) U.S. Cl. 434/365

(57) ABSTRACT

A method of authoring experiential learning content includes displaying an authoring window to author the experiential learning content when a request is made to author the experiential learning content; and creating a virtual world by loading and arranging 3D objects and a 2D objects, in the authoring window, which corresponds to a scenario of the experiential learning content. Further, the method includes defining an Action-zone that determines a position where a user is merged in the virtual world; and defining a state by dividing the scenario into a plurality of steps as time goes by based on the scenario to play the experiential learning content from a specific time point, respectively. Furthermore, the method includes defining a processing routine of an event occurred in the state; and authoring the experiential learning content according to the defined Action-zone, the defined state, and the defined processing routine.

### CROSS-REFERENCE TO RELATED APPLICATION(S)

The present invention claims priority of Korean Patent Application No. 10-2010-0107502, filed on Nov. 01, 2010, which is incorporated herein by reference.

### FIELD OF THE INVENTION

The present invention relates to an learning content authoring using a computer; and more particularly, to an apparatus and a method for authoring 3D content for experiential learning, in which a 3D screen or interactions on a 3D screen is defined, for projecting an image of a user to allow the user to perform learning.

### BACKGROUND OF THE INVENTION

An experiential learning system indicates a system for allowing a user either to go on a field trip to a subway station or a museum or to learn language from a native speaker by projecting an object image of the user into a space of the subway station or the museum, which is virtually realized using 3D technology, such that the object image of the user projected on the 3D content screen shows a preset action in association with the 3D content screen.

In the experiential learning system, it is essential to author 3D content for preparing various 3D experiential spaces to which the user image taken with a camera is projected and for enabling an interaction of the 3D content according to user motions in the 3D experiential spaces.

However, in the prior art, only a method of combining a user image with a background image to display the combined image as if a learner and a teacher are in the same place is realized, but there is no proposal for 3D content authoring technology for preparing various 3D experiential spaces to which a user image taken with a camera is projected and for enabling the interactions of the 3D content according to user motions in the 3D experiential spaces.

### SUMMARY OF THE INVENTION

In view of the above, the present invention provides experiential learning content authoring apparatus for and method of authoring 3D content for experiential learning, in which a 3D screen or an interaction on a 3D screen is defined, for projecting an image of a user to allow the user to perform learning.

In accordance with a first aspect of the present invention, there is provided a method for authoring experiential learning content. The method for authoring the experiential learning content includes displaying an authoring window to author the experiential learning content when a request is made to author the experiential learning content; creating a virtual world by loading and arranging a 3D objects and a 2D objects, in the authoring window, which corresponds to a scenario of the experiential learning content; defining an Action-zone that determines a position where a user is merged in the virtual world; defining a state by dividing the scenario into a plurality of steps as time goes by based on the scenario to play the experiential learning content from a specific time point, respectively; defining a processing routine of an event occurred in the state; and authoring the experiential learning content according to the defined Action-zone, the defined state, and the defined processing routine.

In accordance with a second aspect of the present invention, there is provided an apparatus for authoring experiential learning content. The apparatus for authoring the experiential learning content includes an authoring unit providing an authoring window in which content is authored, recognizing authoring information input from the authoring window, and creating a virtual world suitable for a preset scenario to author the content.

Further, the apparatus for authoring the experiential learning content includes an emulation controller executing the content as a preview in the authoring window; and an event processing unit executing a corresponding event using a processing routine of processing respective events in the content, which are input to be suitable for the scenario. Furthermore, the apparatus for authoring the experiential learning content includes a window manager managing a camera to create a screen of forming the virtual world and positional relationship between virtual objects in the virtual world.

In accordance with an embodiment of the present invention, there is provided an authoring apparatus for authoring 3D content for experiential learning, in which a 3D screen or an interaction on the 3D screen is defined, by projecting a user image to allow the user to perform learning. The authoring apparatus defines a state and an Action-zone based on a scenario for the learning on the 3D screen and projects the 3D user image into a subway station, a museum, and the like, in which the state and the Action-zone, and the like, are defined, to allow the user to have virtual experience in the corresponding space, so that the user may have experience as if existing in actual space and learning effect may be increased.

Further, a learner, a teacher, and a virtual object form a virtual world together and a learner in the virtual world naturally acts according to a motion of a learner in real world so that a remarkable variety of experiential feeling known very effective in learning language may be provided in comparison to an existing method. Moreover, a variety of experiential environments may be constructed with relatively small expense in building an actual language-learning village and the constructed 3D content may be utilized infinitely so that high quality language learning can be provided to many learners.

### BRIEF DESCRIPTION OF THE DRAWINGS

The objects and features of the present invention will become apparent from the following description of embodiments given in conjunction with the accompanying drawings, in which:

FIG. 1 is a block diagram illustrating an experiential learning content authoring apparatus in accordance with an embodiment of the present invention;

FIG. 2 is a flowchart illustrating operation of authoring an experiential learning content in accordance with the embodiment of the present invention;

FIG. 3 is a view illustrating a window for authoring the experiential learning content;

FIG. 4 is a view illustrating a window for creating an object tree;

FIG. 5 is a view illustrating a window for setting attribute of a project;

FIG. 6 is a view illustrating a window for setting attribute of an object;

FIGS. 7, 8, and 9 are views illustrating a window for arranging an object using a pre-camera;

FIGS. 10 and 11 are views illustrating a window for arranging an object using a WYSIWYG camera;

FIG. 12 is a view illustrating a window in which an Action-zone is arranged;

FIG. 13 is a view illustrating a combination window when a learner is in an Action-zone;

FIG. 14 is a view showing a window for setting Action-zone list and attribute thereof;

FIG. 15 is a view showing a window for setting state list and attribute thereof;

FIG. 16 is a view illustrating a window for setting an event manager and attribute thereof;

FIG. 17 is a view illustrating a window for editing an instruction of a teacher to perform a scenario;

FIG. 18 is a view illustrating a script editing window;

FIG. 19 is a view illustrating a window for setting attribute of an event manager;

FIG. 20 is a view illustrating an emulation window;

FIG. 21 is a view illustrating an emulation control window; and

FIG. 22 is a view illustrating a window in which content is executed in an emulation mode.

### DETAILED DESCRIPTION OF THE EMBODIMENTS

Hereinafter, embodiments of the present invention will be described in detail with reference to the accompanying drawings which form a part hereof.

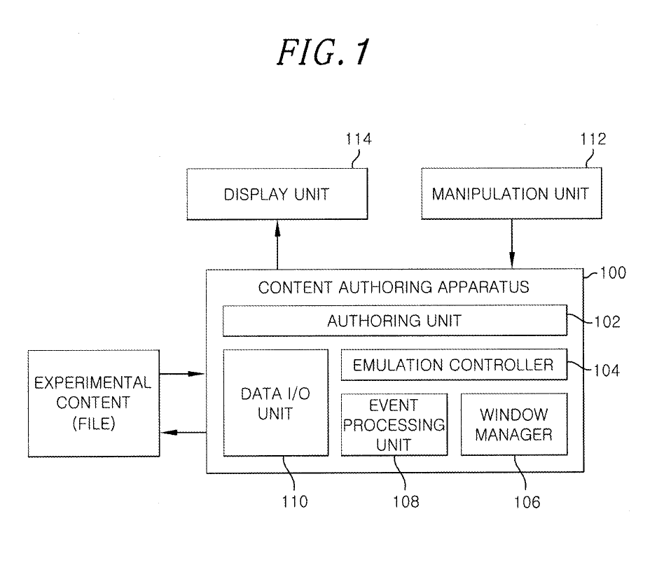

FIG. 1 is a block diagram illustrating an experiential learning content authoring apparatus 100 in accordance with an embodiment of the present invention.

Referring to FIG. 1, an authoring unit 102 provides user interface (UI) enabling a user to author experiential learning content, calls functions of internal modules based on a user input through the UI to create content corresponding to the user input, and displays the created content on a display unit such that the user may check the created content.

A data input/output (I/O) unit 110 stores the content created by the user for the experiential learning in a normalized form that may be used in an experiential learning system, and call the stored content again for editing.

An emulation controller 104 maps an emulation input by a user to an input in an actual system such that a preview showing how the experiential learning content created by the authoring unit 102 works and calls lower modules to process an event and to create a window.

An event processor 108 calls and carries out a process routine, corresponding to input user event information with respect to an input from the user through a manipulation unit 112.

A window manager 106 manages an intrinsic parameter and an extrinsic parameter of a virtual camera, positional relationship between a camera and virtual objects for creating an output screen, and provides function such as movement of Action-zones and screen effects.

A manipulation unit 112 is a user interface unit allowing a user to input information for the authoring of experiential learning content, such as a keyboard, a mouse, and the like. The keyboard may include a plurality of numeric keys, character keys, and function keys and may generate key data corresponding to a preset key when the preset key is pressed by the user.

A display unit 114 includes a monitor and a speaker, displays a content authoring by input from the manipulation unit 112 while the experiential learning content is authored by the authoring unit 102, and displays an executing window of the experiential learning content when the experiential learning content is executed by the emulation controller 104.

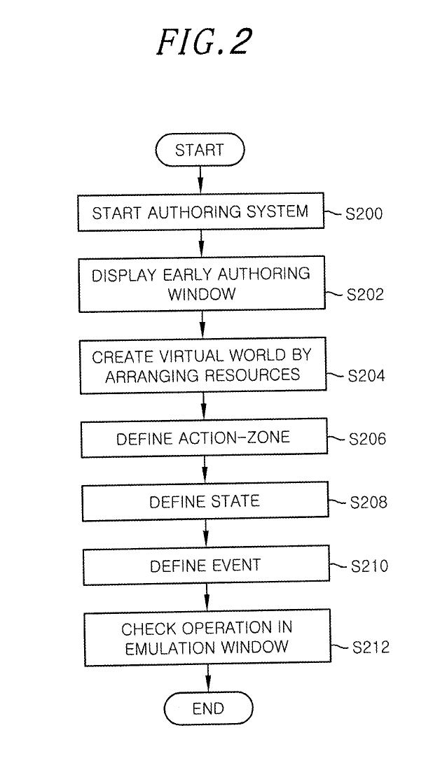

FIG. 2 is a flow chart illustrating an operation of authoring an experiential learning content in accordance with an embodiment of the present invention. Hereinafter, the embodiment of the present invention will be described with reference to FIGS. 1 and 2 in detail.

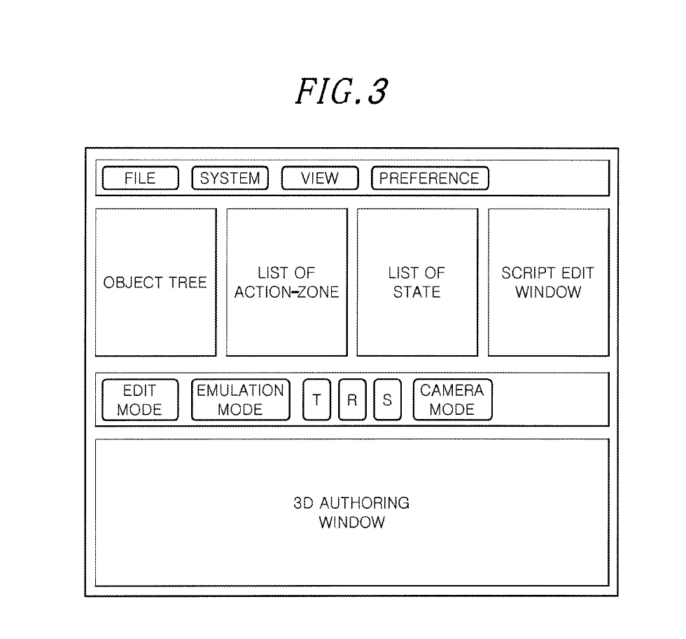

First, when a user inputs a key for authoring an experiential learning content through the manipulation unit 112 in step S200, the key input is input to the authoring unit 102 such that an authoring window including a docking window for displaying a menu bar, an object tree window, an Action-zone list window, a state list window, and a script edit window and a 3D authoring window is displayed on the display unit 114 by the authoring unit 102 as illustrated in FIG. 3 in step S202.

When a user selects a menu bar in the authoring window through the manipulation unit 112, the authoring unit 102 creates a project and creates an object tree by building a 3D objects and a 2D objects. In this case, the concept of a group is supported. The group is a set of 3D objects and 2D objects having similar functions and is advantageous to author content easily by setting visibility and positional movement to the objects at the same time.

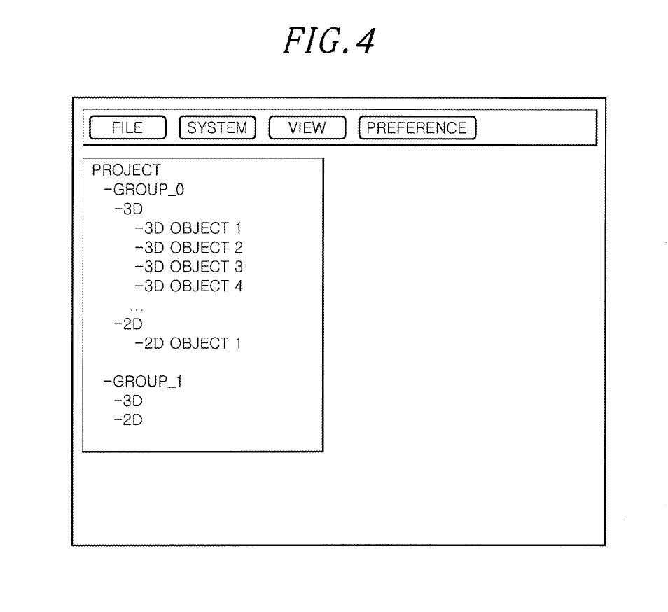

In the object tree, a tree is supported and various hierarchical structures are supported. That is, another 3D objects may be used as the child of a 3D objects. By doing so, information on a position and rotation of the parent is inherited to the child so that a 3D screen may be easily expressed. For example, in a case of expressing a moving human arm with an apple, when the human hand is assigned to the parent and the apple is assigned to the child, an author gives movement information just to the human hand then the apple in the hand moves with the human hand. The object tree created as such is shown in FIG. 4.

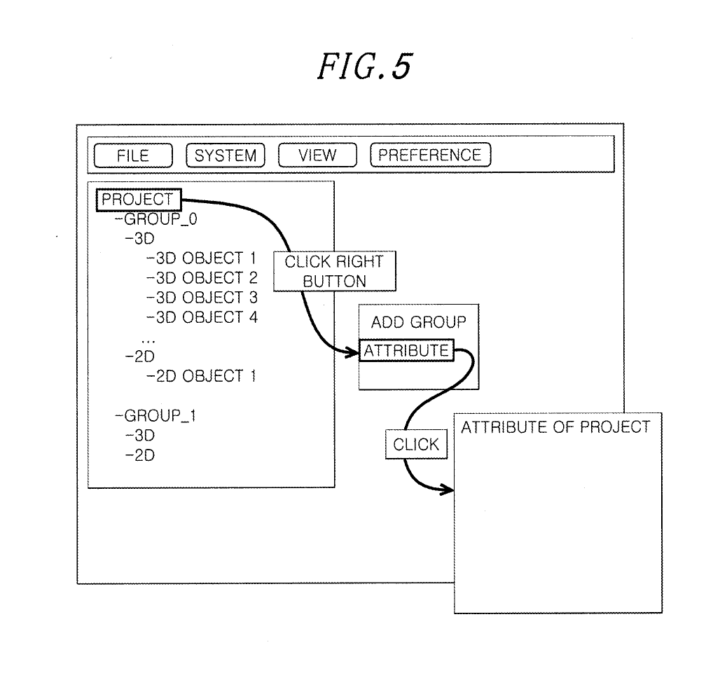

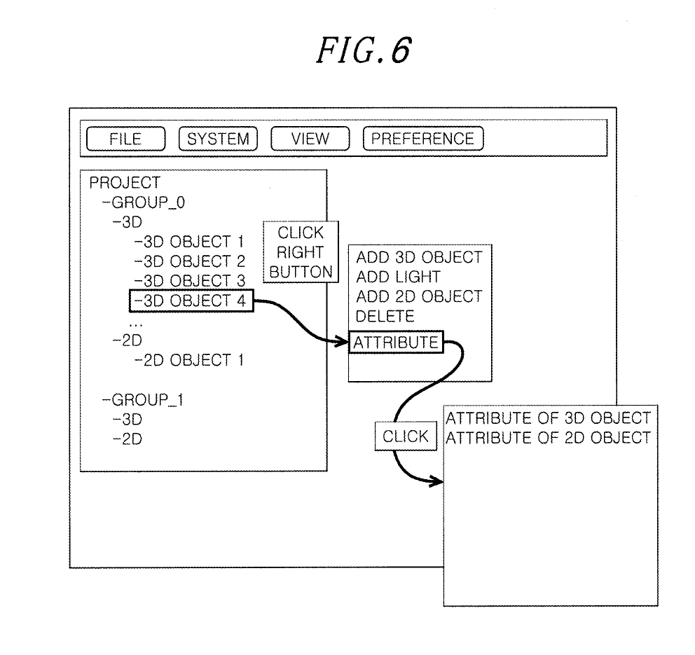

Several commands may be given to items of the object tree by clicking with a mouse. FIG. 5 shows menus seen when the project is clicked with a mouse and FIG. 6 shows menus seen when a group, a 3D objects and a 2D objects are clicked with a mouse. In the menus, a group may be added, attribute of a project may be changed, a 3D objects and a 2D objects may be added and deleted, and attribute of the 3D objects and the 2D objects may be changed.

A user who authors an experiential learning content may select actual 3D and 2D resources to be connected with the items of the object tree in the attribute edit menu of 3D and 2D objects, which exist in the object tree as, illustrated in FIGS. 5 and 6 and may change size and positions thereof.

Moreover, the experiential learning content authoring apparatus provides a function of previewing the created virtual world. The preview function is enabled in the 3D authoring window as illustrated in FIG. 3 and two camera modes are supported for the preview function. That is, a free camera mode and a WYSIWYG camera mode are supported, wherein the free camera mode is a mode where a user freely adjusts a position and an angle of a camera and wherein the WYSIWYG camera mode is a mode of displaying the virtual world on the screen using position and angle information of an acquired camera of a classroom to be serviced but in the WYSIWYG camera mode a user cannot adjust the angel of the camera because of using pre-stored camera information.

The two camera modes are significant for authoring of the experiential learning content. The free camera mode is advantageous to shape overall virtual world by moving a camera here and there and by arranging objects and Action-zones in the overall virtual world. However, it is difficult to predict how the authored experiential learning content is shown on an actually serviced screen and educational elements that needs to be seen to a user may not be seen to the user at a desired position.

The WYSIWYG camera mode does not provide a function of enabling a user to move a camera to shape overall virtual world, but may show how an image of a classroom to be serviced is configured because the information on the camera of the classroom to be serviced is read in advance. Moreover, the WYSIWYG camera mode has the camera information in the classroom to be serviced, and a WYSIWYG camera is used in an emulation mode where an actual motion is emulated.

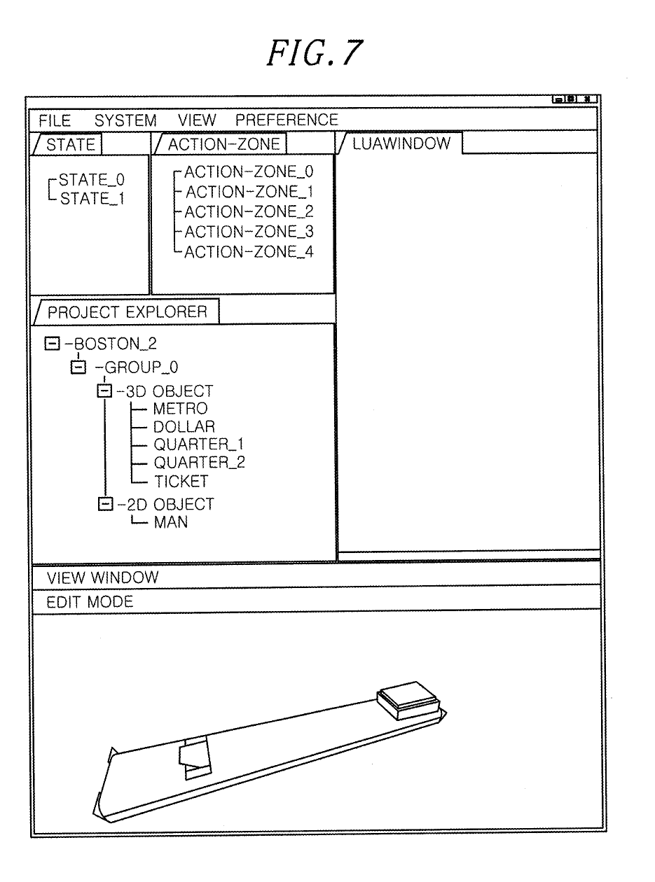

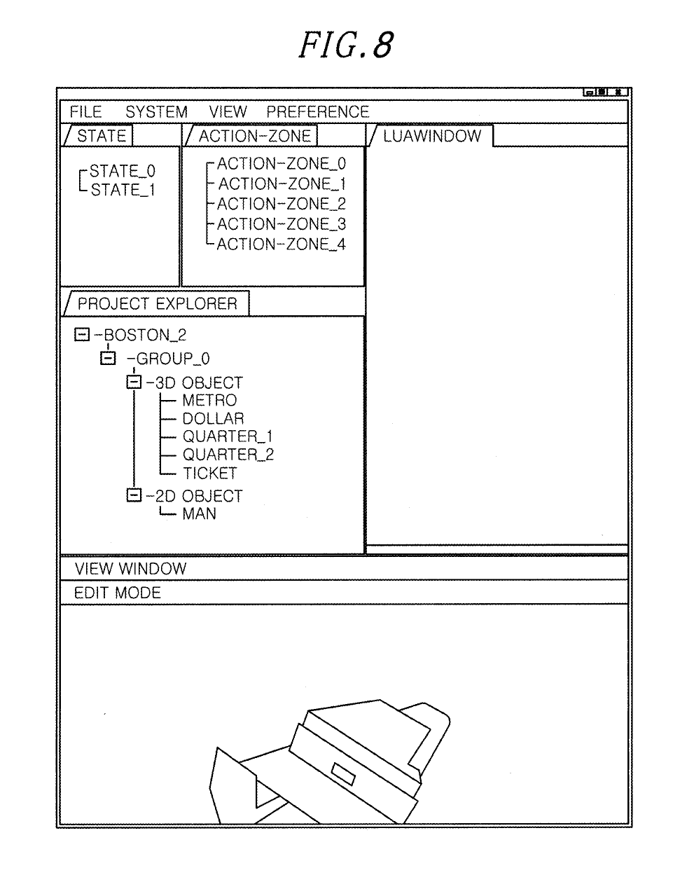

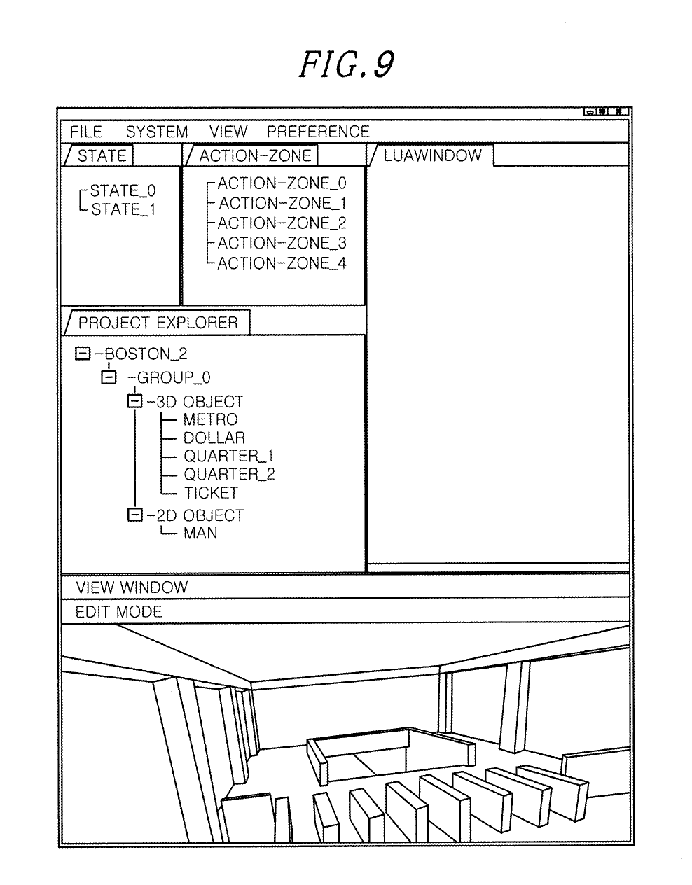

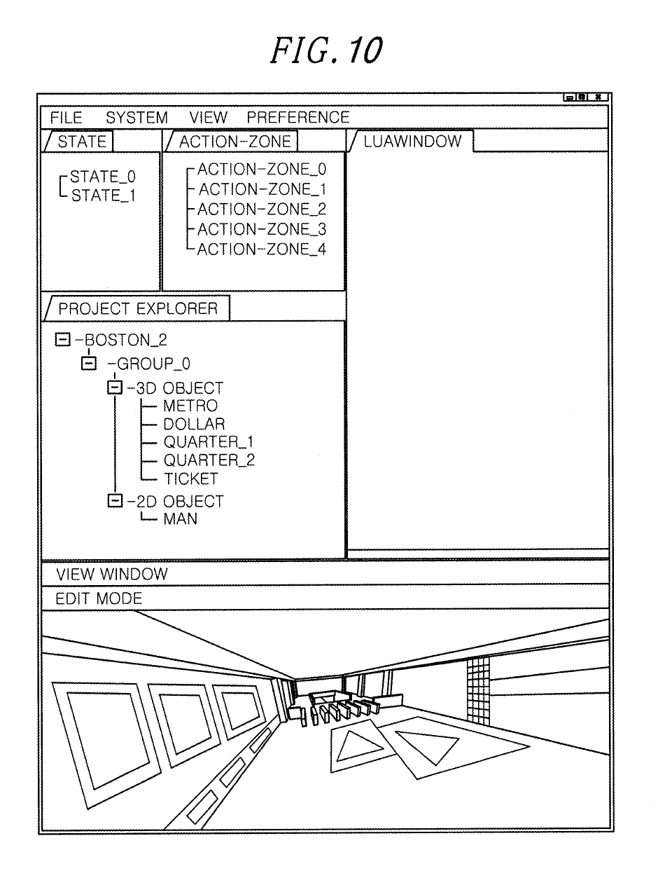

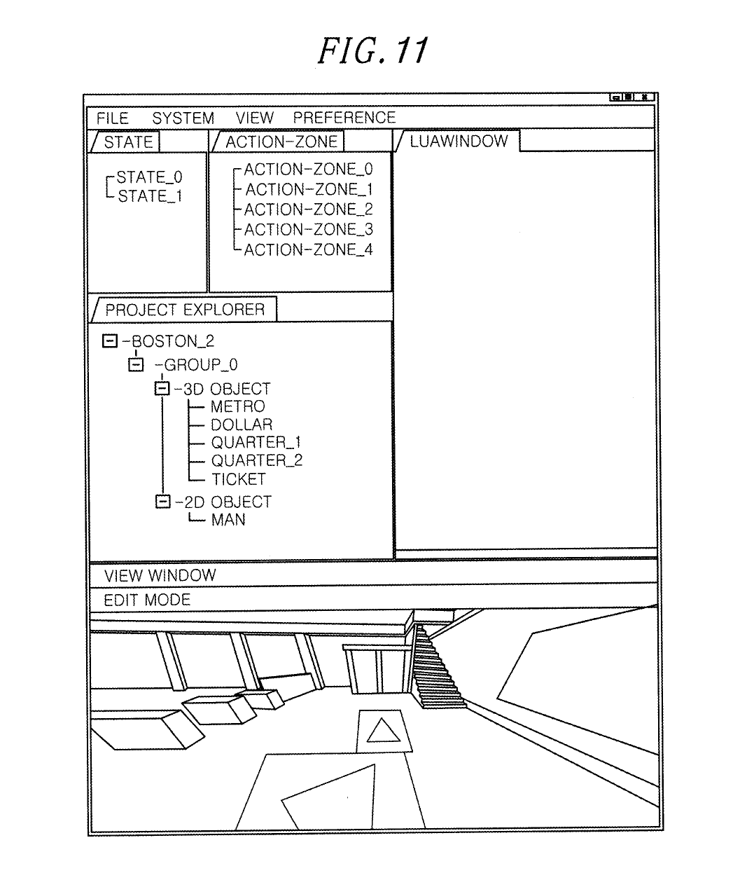

FIGS. 7, 8, and 9 illustrate displaying overall virtual world using a free camera and arrangement of objects. FIGS. 10 and 11 illustrate observation of a screen to be serviced using a WYSIWYG camera and arrangement of objects.

A user creates a virtual world by adding and deleting groups, 3D objects, and 2D objects suitable for a given scenario by clicking the groups and objects with a mouse. Then, the authoring unit 102 creates the virtual world by combining the groups, the 3D objects, and the 2D objects according to the user input through the manipulation unit 112 in step S204.

Next, the virtual world may be created by loading resources to the 3D objects and the 2D objects using the attribute change menu, by clicking objects with the mouse and by dragging and dropping the object to position the clicked objects or by directly inputting position coordinates of the object in the attribute menu.

Particularly, when the virtual world is created by dragging and dropping the objects with the mouse, the objects are arranged by moving the free camera properly for the precise 3D position and direction of the 3D objects using 2D movements of the mouse. A user may check whether the 3D and 2D objects are at desired positions through the free camera and may see a screen of the WYSIWYG camera to check how the 3D and 2D objects are seen in the classroom to be actually serviced. In this case, rankings of the objects to be moved together are set in the object tree so that the objects may be easily moved together.

The experiential learning content authoring apparatus supports concept of an Action-zone. The Action-zone is a rectangular plane of 3 m×3 m. The Action-zone is introduced due to key feature of an experiential learning system called mixed reality.

The experiential learning system is based on the mixed reality in which real and virtual worlds are merged with each other, so that it is very important where of the virtual world created with the virtual objects a learner appears. For example, in the virtual space such as a subway station, a user buys a ticket at a ticket booth from a station employee, goes down to the platform through a ticket gate, and gets on the train at the station platform as a scenario flows. In this case, since positions of the camera and the learner are fixed in the actual space, the position of the learner needs to be fixed at a fixed place in the virtual space and the virtual world needs to move toward the learner. However, it is difficult for a user to set every position and rotation value of the virtual world being changed from moment to moment using the experiential learning content authoring apparatus as the scenario flows and to intuitionally show several virtual worlds. There is a difficulty of authoring the experiential learning content such that the learner needs to move as the scenario flows but the virtual world move reversely.

The concept of the Action-zone proposed by the present invention is a plane of 3 m×3 m in which a space where a learner stands in the actual space is mapped to the virtual worlds as it is. That is, when the Action-zone is arranged where a learner needs to stand in the virtual world created in step S204, the virtual worlds moves considering the center of the Action-zone as a starting point when the experiential learning content is serviced so that the virtual world focusing the Action-zone may be displayed on a screen.

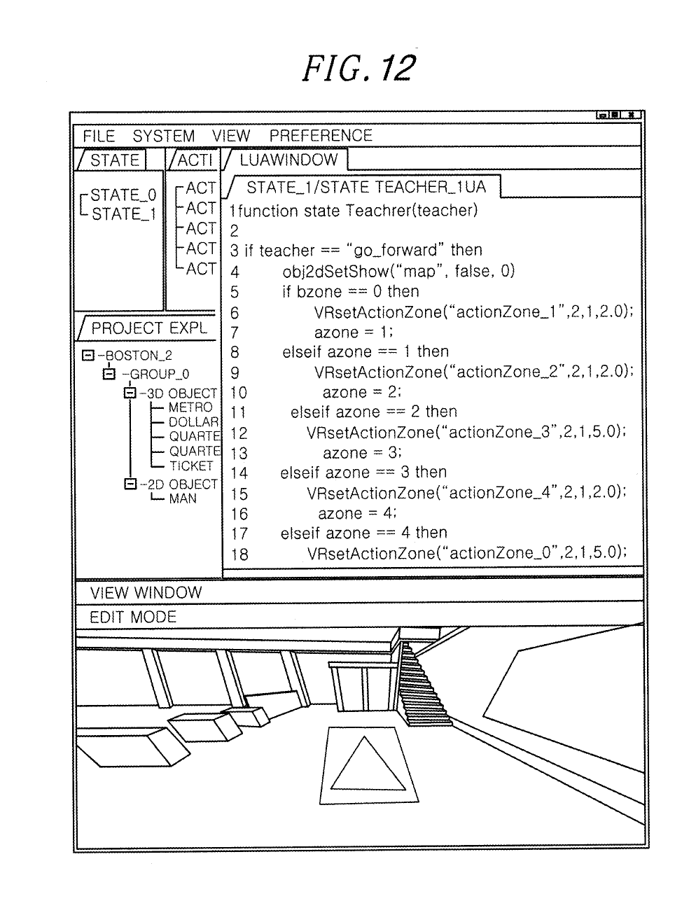

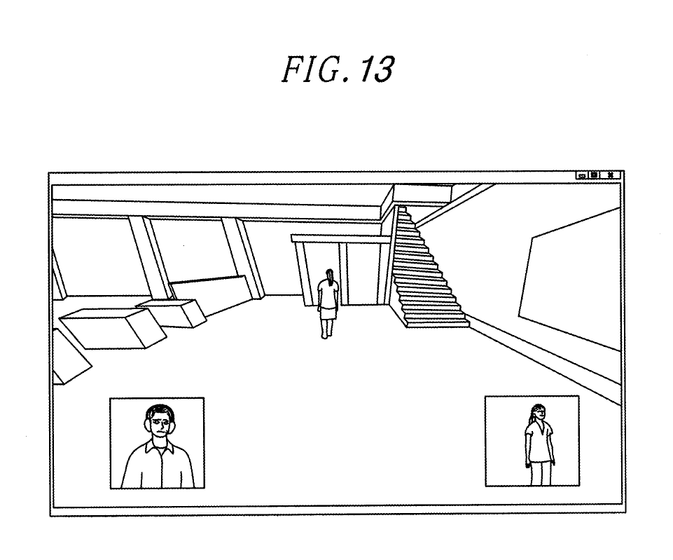

For example, in order to implement content in which a learner buys a ticket from a station employee at the ticket booth, goes down to the station platform through the ticket gate, and gets on the train at the station platform, the Action-zones are arranged in front of the ticket booth, as illustrated in FIGS. 10 and 11, the ticket gate, and stairs, at passages of the subway station, and at the station platform. That is, when a user arranges the Action-zones as illustrated in FIG. 12, a learner is merged and appears at the ticket booth as illustrated in FIG. 13 while the content is serviced.

When a user arranges the Action-zone at a place, where the learner is positioned, in the authoring window as the scenario flows, the authoring unit 102 defines the Action-zone by arranging the Action-zone at a place corresponding to the content authoring window according to the user input in step S206.

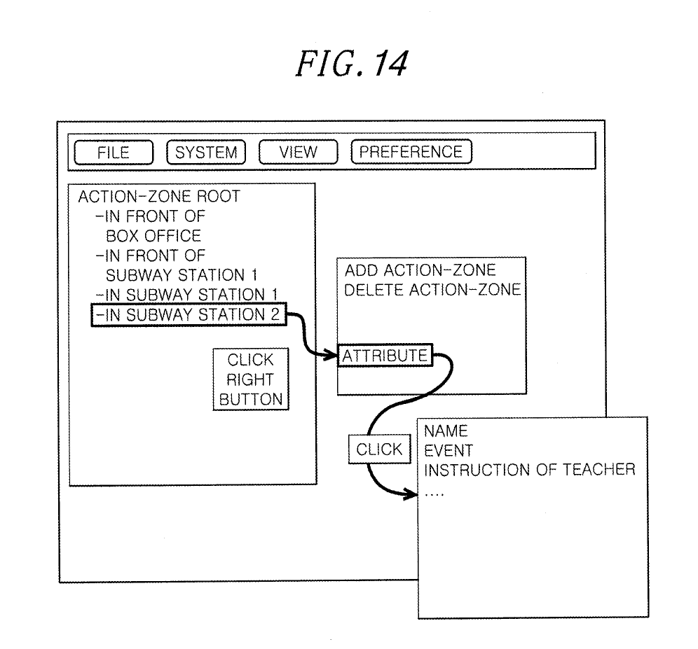

The Action-zone, as illustrated in FIG. 14, may be added and edited in the Action-zone list window of the authoring window. The Action-zone list window manages whole list of the Action-zones in the project and may add and eliminate the Action-zones, and change attribute of the Action-zone by clicking items with a mouse. The attribute of the Action-zone may have a name, a position, and a rotation value.

Moreover, the content authoring apparatus provides the concept of state. The state divides the content into time flows. For example, in the content of experiencing a subway station, the state may be divided into time to have a conversation with a station employee to buy a ticket, time to wait for a train at the station platform, and time to get on the train. After the division of the state, events are defined state by state to play the scenario. A teacher in charge of the learning may be a reference time point to move toward a desired state anytime.

A user inputs state in the authoring window according to the above-mentioned concept for the authoring of the experiential learning content, in this case, the authoring unit 102 defines the state about the content according to the state input from the user in step S208.

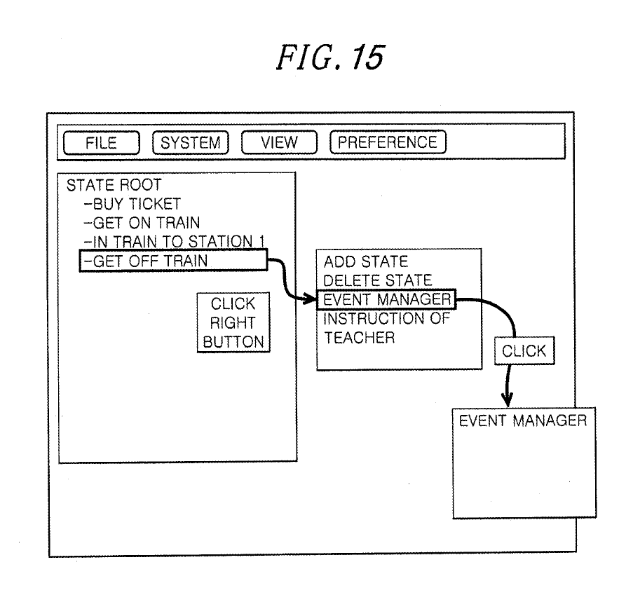

The state, as illustrated in FIG. 15, may be added and edited in the state list window of the authoring window. The state list window manages whole list of the states in the project and may add and eliminate the states, and change attribute of the state by clicking items with a mouse. The attribute of the state may have a name, an event, an instruction of a teacher to perform the scenario, and the like.

The event, among the attributes of the state, defines a process routine on an event that could be generated in a corresponding state. In this case, there may be the generatable event such as touches to a learner and a virtual object, gesture of the learner, the instruction of the teacher to perform the scenario, starting of a state, ending of the state, and a periodic event by timer. The process routine when a corresponding event is generated may be defined by Lua script programming.

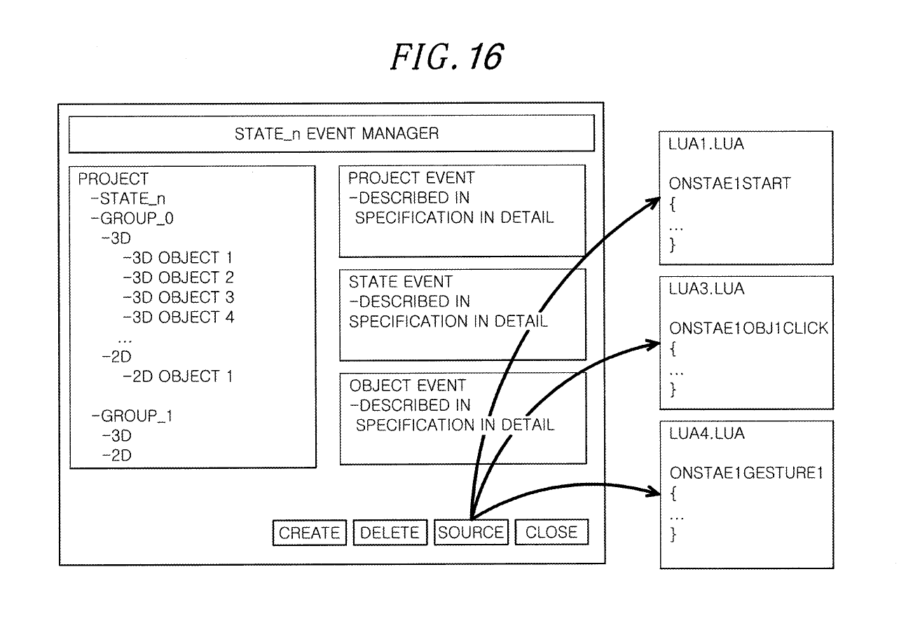

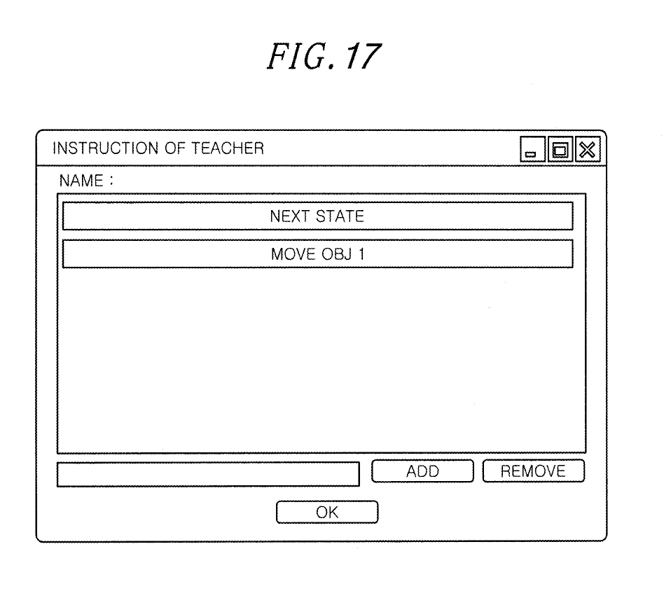

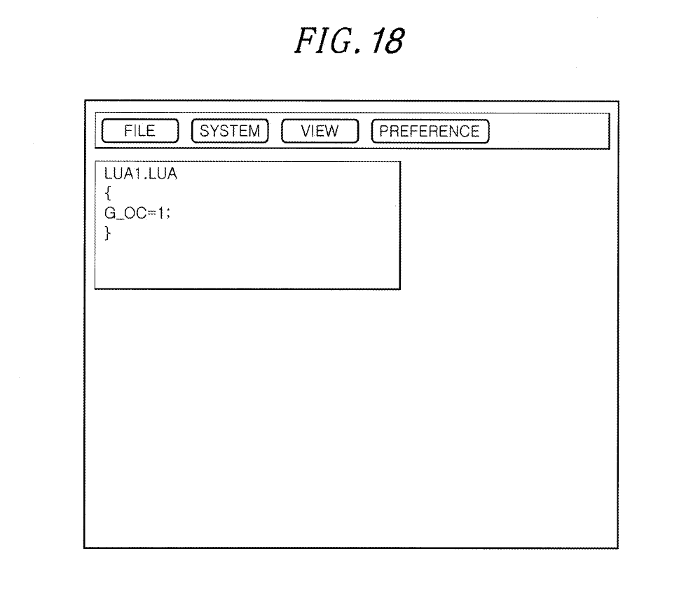

For example, in a buy-a-ticket state of the subway station experiential content, a command to move the virtual world to the Action-zone in front of a station employee and a command relating to sound playing may be defined to a state starting event, a command to display payment may be defined to a gesture event of a learner, and a command to move to a station platform state by the instruction of the teacher to perform the scenario may be defined after that. All events processing routine excluding the instruction of the teacher to perform the scenario may be authored by an event manager UI as illustrated in FIG. 16. The instruction of the teacher to perform the scenario is authored such that an editing window for the instruction of the teacher as illustrated in FIG. 17 assigns a name of the instruction of the teacher which is used in the corresponding state and the event manager writes a script program. A user may edit the Lua script in the Lua script-editing window provided by the authoring window. The Lua script-editing window, as illustrated in FIG. 18, provides a function of writing and editing a script command.

Next, a user inputs a state event corresponding to the state. The authoring unit 102 defines the state event about the content based on information about the state event input by the user in step S210.

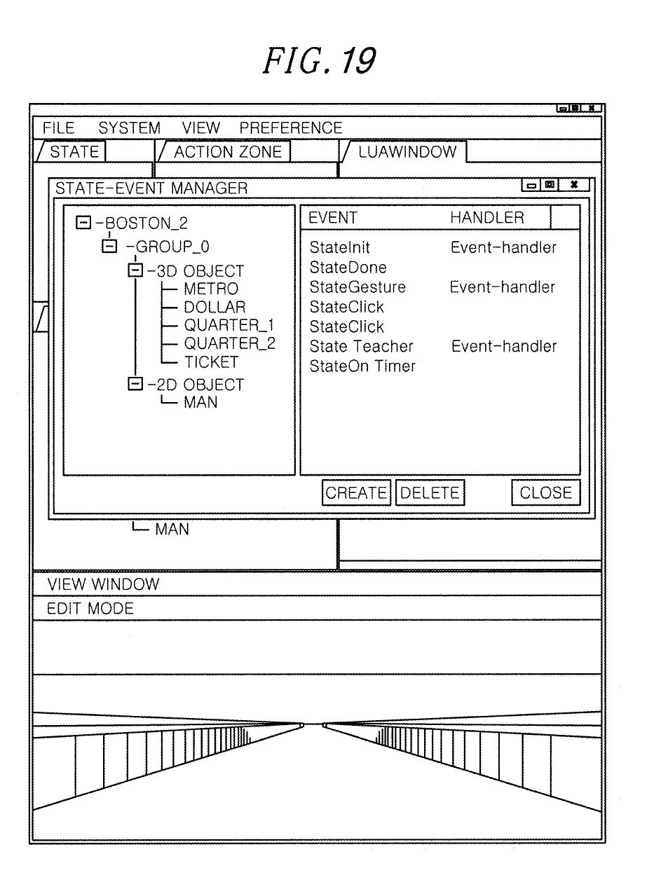

A user defines the state event through an event manager as illustrated in FIG. 16. The event manager may be created by pressing an event edit button in a state attribute window as illustrated in FIG. 15 and the created event manager has the form as illustrated in FIGS. 16 and 19. In the event manager window, a project title, a state name, and an object tree appear in the left-side window and an event list appears in the right-side window.

When a user selects one item of the project, the state, and the object tree in the authoring window shown in FIG. 16, an event list corresponding to the item selected by the user appears in the right-side window. The user clicks a desired item of the event list appeared in the right-side window and selects one of menus such as ‘create,’ delete,’ ‘source,’ and ‘close’ listed at the lower side of the right-side window to assign an event processing routine.

Here, the menu ‘create’ is to create a Lua function file for programming a corresponding event processing routine and the menu ‘delete’ is to delete the Lua function file corresponding to the event. The menu ‘source’ is to show the Lua function of the corresponding event in the script edit window such that the user may directly edit the corresponding Lua function. The user may program a very-definite event processing method in the Lua script edit window to add an interaction to the content.

If a user wants to add the instruction of the teacher, the user opens an editing window for the instruction of the teacher before opening the event manager to write the instruction of the teacher at a corresponding state, and selects the edit menu for the instruction of the teacher in the event manager window to perform the script programming.

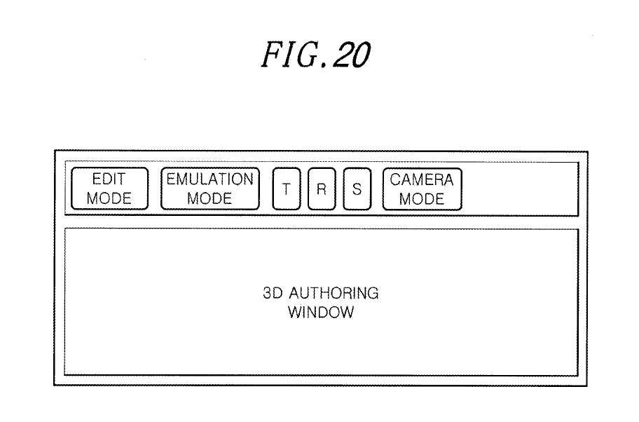

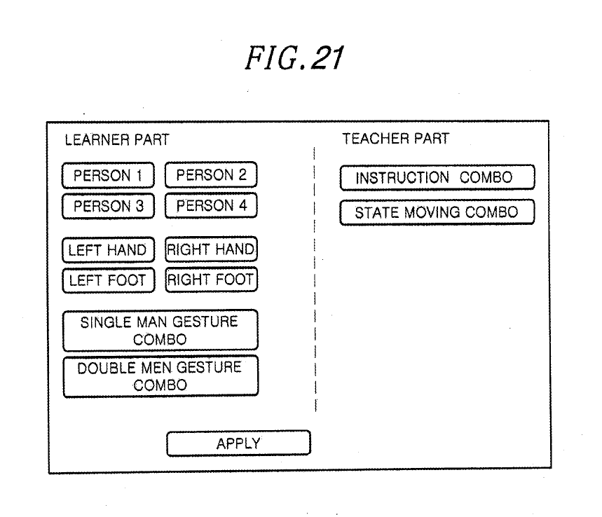

The content authoring apparatus in accordance with the embodiment of the present invention provides an emulation function. The emulation function enables a user to preview how the authored content appears and operates on a service screen. The emulation function shows the service screen in the 3D authoring window as illustrated in FIG. 20, emulates an event on the screen on which the authored content is serviced as illustrated in FIG. 21 through an emulation control window, and enables the user to know how the authored content operates actually, so that the user may verify whether the content is authored well as the scenario and whether there is an operational error.

The emulation function is started by pressing an emulation mode button in the authoring window as illustrated in FIG. 20 and an initial scene graph is created as a user's intend and appears in the 3D authoring window. In the emulation control window, as illustrated in FIG. 21, an event signal may be emulated by dividing the 3D authoring window into a learner part and a teacher part. Events to be emulated includes a picking emulation indicating touches against body of a learner and a virtual object, gesture emulation of the learner, and an action emulation for the instruction of the teacher.

In the picking emulation, a user selects a person who performs picking in the emulation control window and a body portion to be in contact with an object. Then, a picking mode is activated. At this time, when a user clicks a virtual object with a mouse or the like, the same result as the object is actually clicked with a corresponding body portion of a learner may be obtained.

The gesture emulation of the learners is classified into a single man gesture emulation and a double men gesture emulation, wherein a single man gesture means a gesture expressed by a single man and double men gesture means a gesture expressed by two or more men together.

When a user selects a person who performs a gesture and presses a selection button corresponding to the gesture in a single man gesture combo-box, the same single man gesture emulated result as a single learner actually takes a gesture may be obtained.

When a user presses a selection button corresponding to the gesture in a double men gesture combo-box, the same double men gesture emulated result as two or more learners actually take a gesture may be obtained.

When a user clicks a combo-box for the instruction of the teacher in the emulation control window, the instructions of the teacher defined in step S210 are listed up. At this time, when the user presses an apply button by selecting a desired instruction of the teacher from the list, the same action emulation result of the instruction of the teacher as a teacher actually takes an action through the UI may be obtained.

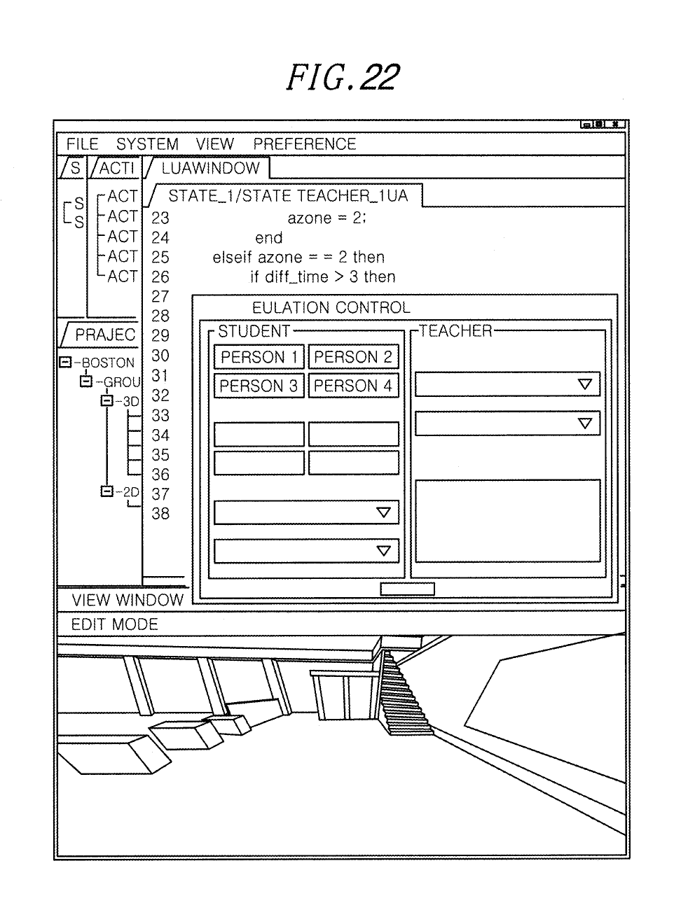

As such, when a user selects the emulation mode while the content is authored, a user may check how the authored content operates precisely as the user intended through a screen on which the authored content is executed as illustrated in FIG. 22. That is, when the emulation mode is selected by a user, the emulation controller 104 executes the content authored by the user and displays the executing content on the display unit 114 as illustrated in FIG. 22, so that the user may inspect the screen on which the authored content is executed in step S212.

By doing so, a user completes the authoring of the content after the user checks that the content is executed precisely as the user intended through the display unit 114. When a portion not operated as the user intended is found, the user moves to the authoring window and corrects the error portion.

As described above, the present invention provides the apparatus for authoring 3D content for experiential learning, in which a 3D screen or an interaction on a 3D screen is defined, for projecting an image of a user to allow the user to perform learning. The experiential learning content authoring apparatus defines a state and an Action-zone based on a scenario for the learning on the 3D screen and projects the 3D user image into a subway station, a museum, and the like, in which the state and the Action-zone, and the like are defined, to allow the user to have virtual experience in the corresponding space. Consequently, the user may have experience as if existing in actual space and learning effect may be increased.

While the invention has been shown and described with respect to the embodiments, it will be understood by those skilled in the art that various changes and modifications may be made without departing from the scope of the invention as defined in the following claims.

What is claimed is:

1. A method for authoring experiential learning content, the method comprising:
displaying an authoring window to author the experiential learning content when a request is made to author the experiential learning content;
creating a virtual world by loading and arranging 3D objects and a 2D objects, in the authoring window, which corresponds to a scenario of the experiential learning content;
defining an Action-zone that determines a position where a user is merged in the virtual world;
defining a state by dividing the scenario into a plurality of steps as time goes by based on the scenario to play the experiential learning content from a specific time point, respectively;
defining a processing routine of an event occurred in the state; and
authoring the experiential learning content according to the defined Action-zone, the defined state, and the defined processing routine.

2. The method of claim 1, further comprising executing the experiential learning content as a preview in the authoring window, executed after the authoring of the experiential learning content, when an emulation mode of the experiential learning content is selected.

3. The method of claim 1, wherein the authoring window includes a docking window displaying a menu bar, an object tree window, an Action-zone list window, a state list window, and a script edit window and a 3D authoring window.

4. The method of claim 1, wherein the creating of the virtual world comprises:
selecting 3D objects and 2D objects in the authoring window to be suitable for the scenario; and
loading resources to the 3D objects and the 2D objects with an attribute change menu and moving the 3D objects and the 2D objects to corresponding positions according to drag and drop input information about corresponding objects to create the virtual world.

5. The method of claim 4, wherein the 3D objects and the 2D objects are created in the form of an object tree and rankings thereof are set in the object tree so that actions of the 3D objects and the 2D objects are defined.

6. The method of claim 1, wherein a list of total Action-zones is managed in an Action-zone list window of the authoring window, and adding of another Action-zone and elimination and attribute change of the Action-zone are performed according to a selection of a key input to an item through a manipulation unit.

7. The method of claim 1, wherein a list of total states is managed in a state list window of the authoring window, and adding of another state and elimination and attribute change of the state are performed according to a selection of a key input to an item through a manipulation unit.

8. The method of claim 1, wherein the event comprises touches of a learner and a virtual object, a gesture of the learner, an instruction of a teacher, starting of the state, and ending of the state.

9. The method of claim 8, wherein a processing routine when the event occurs is defined by Lua script programming.

10. An apparatus for authoring experiential learning content, comprising:
an authoring unit providing an authoring window in which content is authored, recognizing authoring information input from the authoring window, and creating a virtual world suitable for a preset scenario to author the content;
an emulation controller executing the content as a preview in the authoring window;
an event processing unit executing a corresponding event using a processing routine of processing respective events in the content, which are input to be suitable for the scenario; and
a window manager managing a camera to create a screen of forming the virtual world and positional relationship between virtual objects in the virtual world.

11. The apparatus of claim 10, wherein when 3D objects and 2D objects are selected in the authoring window to be suitable for the scenario, the authoring unit loads resources to the 3D objects and the 2D objects with an attribute change menu and moves the 3D objects and the 2D objects to corresponding positions according to drag and drop input information about corresponding objects to create the virtual world.

12. The apparatus of claim 10, wherein the authoring unit defines an Action-zone which determines a position where a user is merged in the virtual world.

13. The apparatus of claim 12, wherein a list of total Action-zones is managed in an Action-zone list window of the authoring window, and adding of another Action-zone and elimination and attribute change of the Action-zone are performed according to a selection of a key input to an item through a manipulation unit.

14. The apparatus of claim 10, wherein the authoring unit divides the scenario into a plurality of steps as time goes by based on the scenario to play the experiential learning content from a specific time point, respectively.

15. The apparatus of claim 14, wherein a list of total states is managed in a state list window of the authoring window, and adding of another state and elimination and attribute change of the state are performed according to a selection of a key input to an item through a manipulation unit.

16. The apparatus of claim 10, wherein the authoring window includes a docking window displaying a menu bar, an object tree window, an Action-zone list window, a state list window, and a script edit window and a 3D authoring window.
